(19) United States
(12) Patent Application Publication
(10) Pub. No.: US 2015/0292987 A1
(43) Pub. Date: Oct. 15, 2015

(54) CLOSING ELEMENT OF A CONTAINER FOR BIOLOGICAL FLUIDS

(71) Applicant: COPAN ITALIA S.P.A., Brescia (IT)

(72) Inventor: Daniele Triva, Bovezzo (IT)

(21) Appl. No.: 14/438,124

(22) PCT Filed: Aug. 27, 2013
(86) PCT No.: PCT/IB2013/058006

§ 371 Date: Apr. 23, 2015

(30) Foreign Application Priority Data
Oct. 23, 2012 (IT) MI2012A001793

(51) Int. Cl. G01N 1/10; G01N 1/22; B01L 3/00; B65B 7/16; B65B 7/28

(52) U.S. Cl. CPC G01N 1/10; B65B 7/161; B65B 7/2842; B01L 3/508; G01N 1/2226; B01L 2300/046; B01L 2300/12

(57) ABSTRACT

A closing element of a container (2) for biological fluids, in particular biological liquids, including a fluid-tight body (3) able to prevent a passage of liquids and gases through the same body (3), and/or sealed in a vacuum condition, the body (3) being couplable at an opening (4) of said container (2) for fluids such as to close the opening (4) and exhibiting at least a perforable portion (5) that can be selectively and through-pierced by a piercing element (7) made of a plastic material, at least the perforable portion (5) being made of a halogenated-type butyl-based polyolefin thermo-setting elastomer exhibiting a Shore A hardness value of less than 40 and proof to liquids and gases, at least the perforable portion (5) being further suitable and configured for elastically re-establishing a fluid-tight condition in order to prevent passage of liquids and gases through the body (3), following an extraction of said piercing element (7) from the perforable portion (5) of the body (3).

### FIELD OF THE INVENTION

The present invention relates to a closing element of a container for biological fluids. The invention further relates to a device for containing and transporting the biological fluids, to a collecting device and to a procedure for removing a quantity of a sample of biological fluid or liquid from a device for containing and transporting the fluids.

The invention is applicable for example with laboratory test tubes for the containing of biological material or material of biological origin, in particular biological liquids, for example urine.

### BACKGROUND

Various types of closing devices are known for containers of biological material or material of biological origin in a fluid or liquid form. The known closing devices, beyond preventing the exit of the contents from the container, can further be made of materials able to prevent risks of contamination of the contents or the external environment, sometimes by an air seal or a seal capacity of a vacuum condition in the container.

Also known are closing devices provided with closing elements made of an elastomer material which can be perforated with a metal needle or with another pointed element so as to enable a selective removal of a part of the contents of the container or test tube, and further able to at least partially close the opening caused by the passage of the needle, so as to prevent exit of the remaining part of the sample. Some known solutions of this type are disclosed for example in the following patent documents: EP0383262, EP0539141, EP0763476, WO9534381, WO9945360, WO03064044.

The cited known solutions are not free of drawbacks. In fact, various of the known solutions include closing elements that are perforable only by use of metal collecting needles, as the closing elements exhibit a degree of hardness such as not to be perforable by plastic elements. The use of metal needles leads to high costs as well as serious problems of disposal of the needles, as after use they are contaminated by biological materials and therefore are subject to application of very restrictive regulations for disposal thereof.

Other solutions include closing elements which can also be perforated by collecting elements made of plastic, but do not exhibit a sufficient ability to re-close the opening generated thereby or a sufficient air seal, and do not enable newly sealing the container after extraction of the collecting element. In other terms, none of the known solutions is fully satisfactory.

### SUMMARY

The concepts herein encompass a closing element of a container for biological fluids, a device for containing and transporting biological fluids, a collecting device and/or a process which enable solving one or more of the drawbacks mentioned herein above.

The concepts herein encompass a closing element which is able to appropriately conserve the material internally of the container and to prevent possible contaminations caused by external agents.

The concepts herein encompass a closing element which enable a fluid seal, a liquid and/or gas and/or gas seal which enables a seal on a vacuum condition in a relative container.

The concepts herein encompass a closing element which enables automatically re-setting, following an extraction of a collecting device thereof, a condition of fluid seal, a liquid and/or gas and/or gas seal which enables a seal on a vacuum condition in a relative container.

The concepts herein encompass a closing element which enables a simple and rapid removal of material from a relative container.

The concepts herein encompass a closing element which realises collecting devices of practical use, relatively inexpensive and easy disposal.

The concepts herein encompass a closing element of a container for biological fluids which is simple and relatively inexpensive to realise.

The concepts herein encompass a device for containing and transporting biological fluids and/or by a collecting device and/or by a process according to what is described in the appended claims.

According to further aspects, which can be taken in combination with any one of the appended claims and/or in any combination among them:
the elastomer material is galvanised and/or is vulcanized with sulphur;
the elastomer material is without lattices of natural origin;
the container internally or externally exhibits at least a projecting element situated at a predetermined distance from the opening, the projecting element enabling resting and maintaining in position the closing element and/or being couplable with a corresponding projection or recess of the closing element so as to improve the reciprocal sealed coupling;
the body or the perforable portion exhibit, according to a transversal section to the preferential direction of perforation or the fluid extraction direction, a shape that is substantially circular or polygonal or elliptical and/or a second having an area comprised respectively between 100 mm² and 340 mm² or between 150 mm² and 270 mm² for the body and/or between 60 mm² and 280 mm² or between 100 mm² and 200 mm² for the perforable portion;
the piercing element and/or the perforating portion of the collecting device are entirely hollow and comprise a passage conduit for the fluid or liquid to be collected from the container;
the collecting device further comprises a small transport tube for the fluid or liquid removed from the container, the tube being couplable and/or fixed to the support portion of the collecting device at a second end of the passage conduit opposite the perforating portion;
the body or the perforable portion exhibit at least a useful continuous containing surface.

In further aspects of the invention, which can be taken in combination with any one of the appended claims and/or in any combination among them, the process further comprises at least one of following steps:
coupling a support portion, connected to the perforating portion of the collecting element, to the cap and/or the container, up to reaching a first operating collecting position, for guiding and maintaining a correct insertion of the perforating portion in the perforable portion;
manipulating the collecting element by a grip portion connected to the support portion; and/or
coupling at least a hooking portion of the collecting element to the cap and/or the container, so as to define a second operating position of non-use and/or transport of the device for containing and transporting fluids.

### BRIEF DESCRIPTION OF THE DRAWINGS

Some embodiments and some aspects of the invention will be described in the following with reference to the accompanying drawings, provided purely by way of non-limiting example, in which:

FIG. 1 is a perspective view of a closing element according to a first embodiment;

FIG. 2 is a view from above of the closing element of FIG. 1;

FIG. 3 is a section view of the closing element made along lines III-III of FIG. 2;

FIG. 4 is a first operating condition of a device for containing and transporting biological fluids comprising a closing element of a type illustrated in FIG. 1, in which a cap is shown transparently so as to evidence the position of the closing element;

FIG. 5 is a second operating condition of the device of FIG. 4;

FIG. 6 is a third operating condition of the device of FIG. 4;

FIG. 7 is a fourth operating condition of the device of FIG. 4;

FIG. 8 is a perspective view of a container being a part of the device of FIG. 4;

FIG. 9 is a lateral view of the container of FIG. 8;

FIG. 10 is a section view of the container made along lines X-X of FIG. 9;

FIG. 11 is a perspective view of a collecting device being a part of the device of FIG. 4;

FIG. 12 is a lateral section view of the device of FIG. 11;

FIG. 12a is a detail of the point of the device of FIG. 12;

FIGS. 13 and 14 are two opposite perspective view of a cap being a part of the device of FIG. 4.

### DETAILED DESCRIPTION

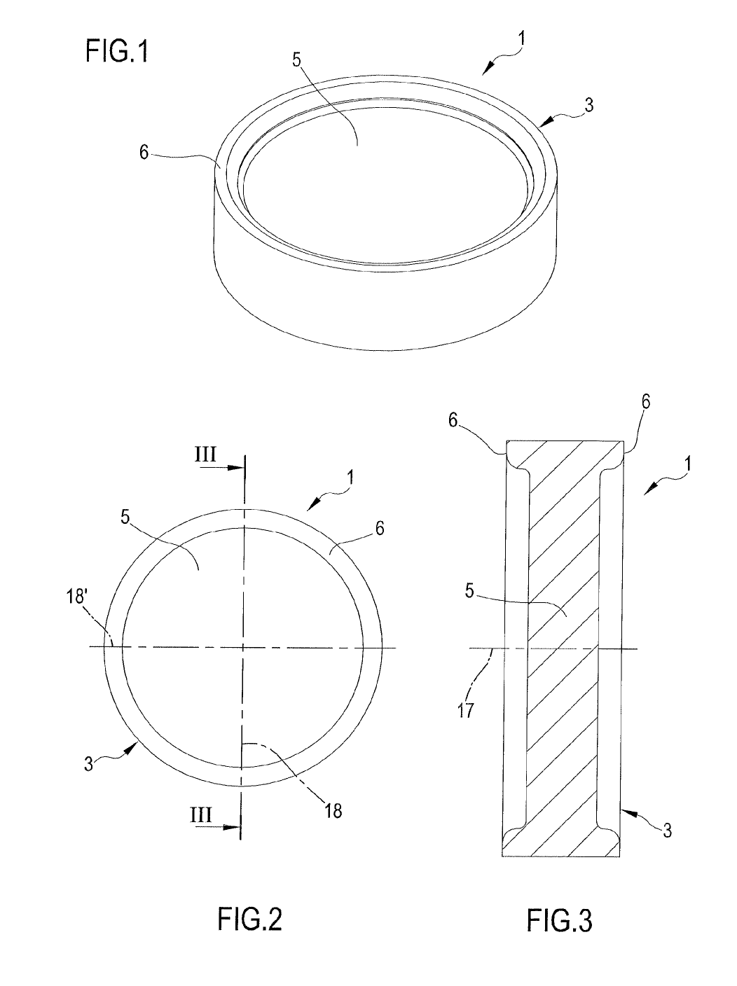

Reference number 1 denotes a closing element of a container 2 for biological fluids, in particular biological liquids, for example urine or blood. The closing element 1, illustrated in detail in FIGS. 1-3, comprises at least a fluid-sealed body 3, able to prevent passage of liquids and gases through the body 3. The body 3 is preferably further sealed in a vacuum condition.

The body 3 is couplable to an opening 4 of a container 3 for fluid for closing the opening 4. The body 3 exhibits at least a perforable portion 5, selectively and through-perforable, by a piercing element 7 made of a plastic material.

The body 3, or at least the perforable portion 5, is made of a butyl-based polyolefin elastomer material of a halogenated type exhibiting a Shore A hardness value of less than 40 and is impermeable to liquids or gases. The material could be a bromine-butyl polymer containing about from 92% to 99% in weight of isobutylene, about 0.5 to 5% in weight of isoprene and about from 0.5 to 3.5% in weight of bromine. In particular, the material can be a butyl bromine polymer containing about from 95% to 97.5% in weight of isobutylene, about from 1 to 2.5% (or from 1.5 to 2.5%) in weight of bromine. Alternatively, the butylic elastomer can be obtained by reacting a quantity of between 95 and 99.5% in weight of isobutylene with a quantity of between 0.5 and 5% in weight of isoprene, and can be halogenated, preferably with bromine, in such a way as to preferably contain between 0.5% and 3% in weight of bromine, in particular between 1% and 2% in weight of combined halogen. The base polymer of the elastomer material can be a brominated isobutene-co-isoprene copolymer or a brominated isoprene-isobutylene copolymer.

The material can exhibit a Shore A hardness value of less than 35, or less than 32, or less than 30 or less than 28. The Shore A hardness value is comprised between 15 and 35, or between 18 and 32 or between 20 and 30 or between 20 and 28. The material is heat-hardening. The material is vulcanized, for example with sulphur.

The portion 5 is able and configured such as to elastic return to a fluid-sealed condition, so as to prevent passage of liquids and gases through the body 3 itself, or so as to maintain the vacuum condition, following an extraction of the piercing element 7 from the perforable portion 5 of the body 3.

The body 3 exhibits a thickness, in at least a perforable portion 5 and according to a preferential direction 17 of perforation and/or according to a fluid extraction direction, of less than 7 mm or less than 6 mm or less than 5 mm or less than 4 mm or less than 3.5 mm and/or comprised between 1 mm and 7 mm or between 2 mm and 4 mm or between 2.5 and 3.5 mm.

The body 3 can exhibit a substantially pastille-shaped conformation and/or substantially cylindrical conformation. The body 3 can exhibit a width, in at least a direction 18, 18′, perpendicular to the preferential direction 17 of perforation, comprised between 10 and 25 mm and/or between 15 and 20 mm and/or between 16 and 18 mm.

The body 3 can exhibit a raised perimeter portion 6 having a greater thickness than that of the perforable portion 5. The perimeter portion can exhibit, for example, a thickness greater by at least 0.5 mm, or at least 1 mm, or at least 1.5 mm with respect to the perforable portion.

The material can exhibit a density comprised between 1 and 1.30 g/cm³ and/or between 1.10 and 1.20 g/cm³ and/or about 1.15 g/cm³.

The material can exhibit a resistance to laceration comprised between 5 and 20 N/mm and/or between 8 and 18 N/mm and/or between 10 and 16 N/mm.

The material can further exhibit a breaking load comprised between 4 and 12 MPa and/or between 5 and 11 MPa and/or between 6 and 10 MPa.

In a preferred embodiment illustrated by way of example, the material can be an elastomer-based mixture or bromine-butyl rubber, vulcanized with sulphur and having a Shore A hardness of between 20 and 30, a density of about 1.15 g/cm³, a resistance to laceration comprised between 8 and 18 N/mm and a breaking load comprised between 6 and 10 MPa.

The molecular structure of the material is very dense and guarantees a very high impermeability to air and gases. Further, a material selected according to the invention exhibits a significant resistance to ageing, ozone and acid and base substances. The presence of the halogenated part with respect to only the olefinic copolymer further enables increasing the curing velocity, the heat resistance and compatibility with other elastomeric materials (or blending).

In some less preferred alternative embodiments, the closing element might further comprise at least a layer of cladding made of a second material, different from the elastomer material and coupled to the body and arranged downstream of the elastomer material and coupled to the body and arranged downstream or upstream with respect to the body in a preferential direction of perforation and/or the closing element might further comprise an aluminium sheet or film coupled to the body and/or a layer of paint of the body with a cladding material or with an impregnating material. In this case the layer of cladding or the sheet might be coupled contactingly with the body.

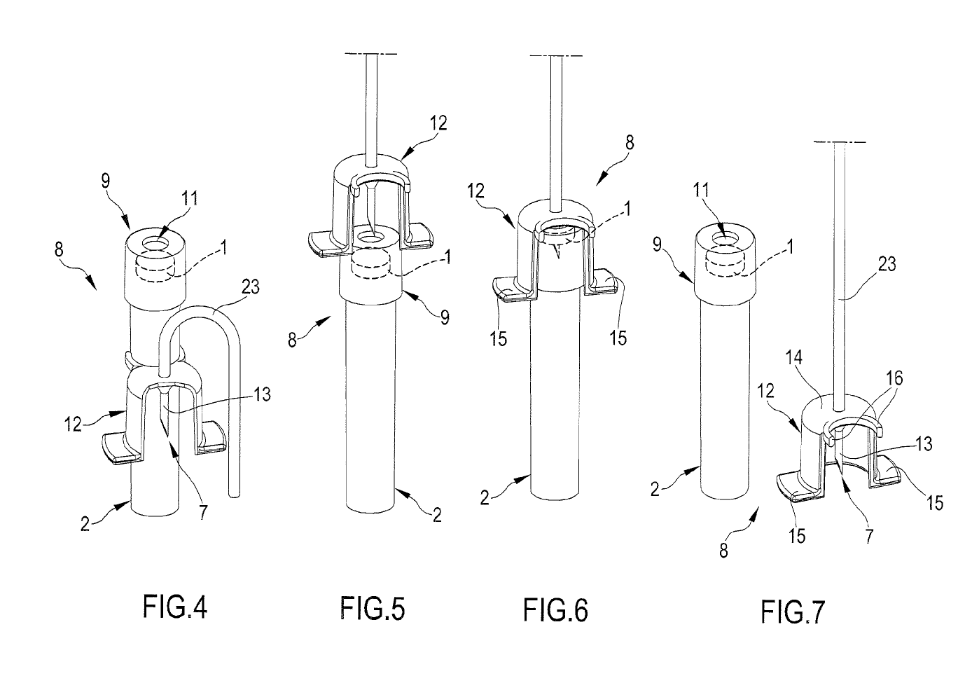

The invention further relates to a device 8 for containing and transporting the biological fluids, illustrated in its entirety in FIGS. 4-7 and comprising: a container 2 for fluids, able to contain at least a fluid, in particular a liquid, for example urine or blood.

The device further comprises a closing element 1, of the above-described type, coupled at an opening 4 of the container 2 for closing the opening 4 and for preventing an exit of liquids and gases from the container 2.

The closing element 1 is further able and configured to elastically re-establish the fluid-tight condition following an extracting of a piercing element 7 from the perforable portion 5 of the body 3. In a case where the container 2 comprises at least a liquid placed in a vacuum condition, the closing element 1 is further able and configured to re-establish the fluid-tight condition, preventing an escape of liquids and gases from the container 2, and maintaining the vacuum condition in the container 2, following an extraction of a piercing element 7 from the perforable portion 5 of the body 3.

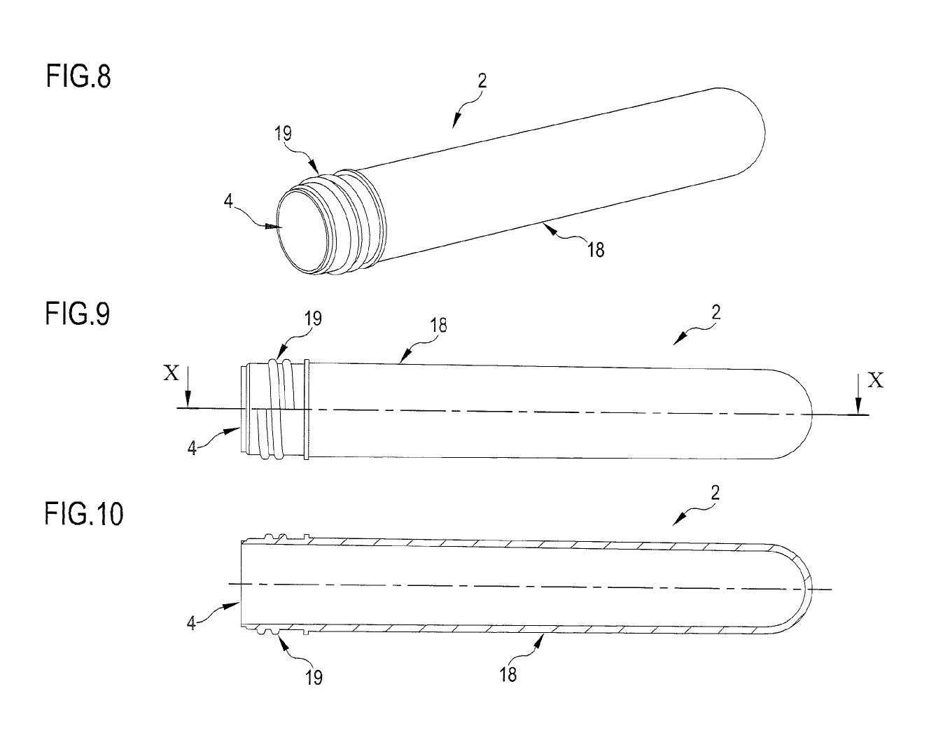

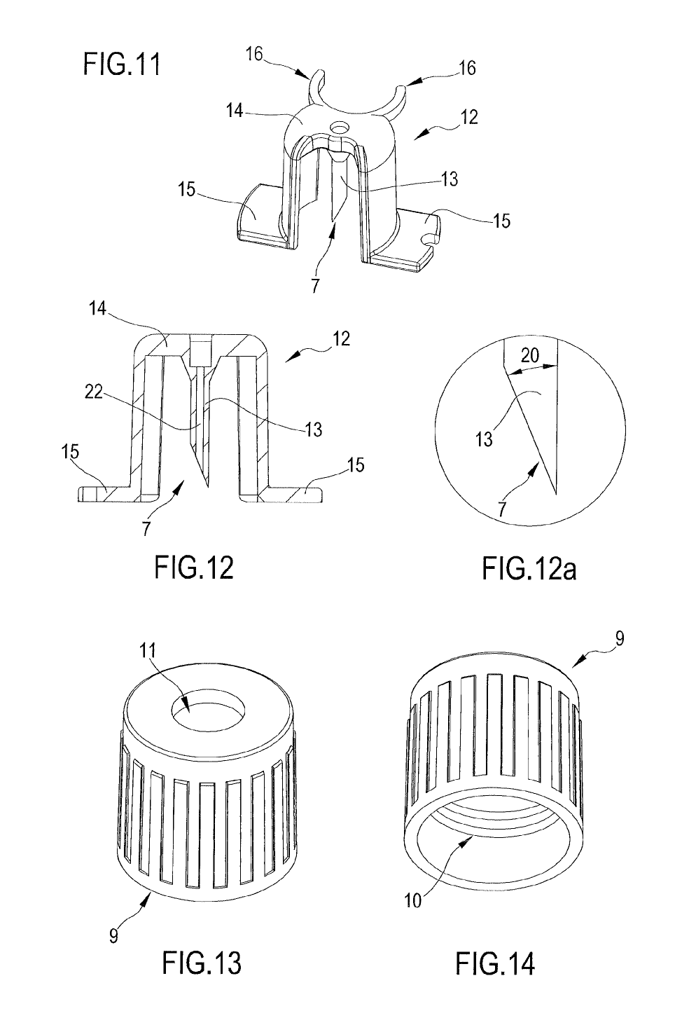

The device 8 for containing and transporting biological fluids can further comprise a cap 9 (illustrated in detail in FIGS. 13 and 14) selectively couplable to the container 2 at the opening 4 so as to maintain the closing element 1 coupled and in a sealed closure position of the container 2. The cap can be provided, on the external lateral surface thereof with reliefs able to facilitate gripping and activation thereof. The closing element 1 can for example be maintained in contact with an upper edge 21 of the container 2 so as to seal the container 2. The container 2 can be for example a test tube 18, illustrated in detail in FIGS. 8-10. In this case the cap 9 can comprise a threaded ringnut 10 selectively couplable to a corresponding thread (19) of said test tube 18, the cap 9 being provided with at least a passage opening 11 enabling an access to the perforable portion 5 of the closing element 1 by a piercing element.

The device 8 for containing and transporting biological fluids can further comprise a collecting device 12 having at least a piercing portion 13 made of a plastic material suitably shaped for defining a piercing element 7 able to selectively perforate the perforable portion 5 of the closing element 1. The piercing portion 13 exhibits, in a section perpendicular to a main longitudinal extension direction, a diameter comprised between 1 and 4 mm, or between 1.5 and 3.5 mm or between 2 and 3 mm or between 2.3 mm and 2.7 mm. The piercing portion 13 is shaped at a point thereof with a profile inclined according to an angle 20 comprised between 10° and 45° or comprised between 15° and 35° or comprised between 20° and 25° such as to facilitate insertion thereof in the perforable portion 5.

In a further aspect, the invention further relates to the collecting device 12, which can further comprise at least a support portion 14 connected to the piercing portion 13 and selectively couplable to the cap 9 and/or to the container 2, in a first operating collecting position, for guiding and maintaining a correct insertion of the piercing portion 13 in the perforable portion 5.

The collecting device 12 can further comprise at least a grip portion 15 connected to said support portion 14 for facilitating manipulation of said perforator element by a user.

The collecting device 12 can further comprise at least a portion an engaging portion 16 enabling a selective coupling of said piercing element to said cap 9 and/or said container 2, in a second operating position of non-use and/or of transport.

The perforating element 7 and/or the piercing portion 13 of the collecting device are internally hollow and comprise a passage conduit 22 for the fluid or liquid to be removed from the container 2. The collecting device 12 can further comprise a transport tube 23 for the fluid or liquid removed from the container. The tube 23 is coupled to the support portion of the collecting device at a second end of the passage conduit 22 opposite the point of the piercing portion.

At least the piercing element 7, or the piercing portion 23, can be entirely made of a plastic material. The collecting device 12 can also be entirely made of a plastic material. In an alternative embodiment, the collecting device 12 could comprise only the piercing portion 13 and therefore coincide with an internally hollow collecting element 7.

In a further aspect thereof, the invention further relates to the use of a closing element 1 of the above-described type for sealedly closing of biological fluids, in particular of biological liquids, for example urine or blood, so as to prevent passage of liquids and gases and/or for sealedly closing a vacuum condition of a container 2 or test tube 18.

In a further aspect thereof, the invention further relates to a process for collecting a quantity of a sample of fluid or liquid, for example urine or blood, from a device 8 for containing and transporting fluids of the above-described type, the process comprising steps of: inserting the piercing portion 13 of the collecting element through the perforable portion 5 of the closing element 1; collecting, from the container 2 of the device 8 for containing and transporting fluids, a predetermined quantity of the sample through the piercing portion 13; and extracting the piercing portion 13 of the collecting element from the perforable portion 5 of the closing element 1, the perforable portion closing elastically such as to re-establish a tight condition of fluids, such as to prevent passage of liquids and gases through the body 3, or for maintaining a vacuum condition in the container 2.

The process can further comprise a step of coupling (FIGS. 5 and 6) the support portion 14, connected to the piercing portion 13 of the collecting element, the cap 9 and/or the container 2, up to reaching a first operating collecting position (FIG. 6), for guiding and maintaining a correct insertion of the piercing portion in the perforable portion.

The process can further comprise the step of manipulating the collecting element by the grip portion connected to the support portion.

The process can further comprise the step of coupling at least a hooking portion of the piercing element to the cap and/or to the container (as illustrated in FIG. 4), so as to define a second operating non-use position and/or transport condition of the device for containing and transport of fluids.

The invention enables obtaining numerous advantages, primarily as it enables obviating one or more of the drawbacks in the prior art.

Further, the invention enables realizing a closing element able to appropriately conserve the material internally of the container and avoid possible contaminations caused by external agents, further enabling seal of fluids, liquids and/or gases and/or a seal of a vacuum condition in a relative container.

Further, a closing element according to the invention enables automatic re-establishment, following an extraction of a collecting device thereof, a sealed condition of fluids, liquids and/or gases and/or a sealed condition of a vacuum condition in a relative container.

A closing element according to the invention further enables a simple and rapid collecting of material from a relative container.

A closing element of the invention further enables realizing collecting devices of practical use, modest cost and/or easy disposal.

Lastly, it is significant that the present invention is simple and economical to realize.

1-10. (canceled)

11. A closing element of a container (2) for biological fluids, the closing element (1) comprising a fluid-tight body (3) able to prevent passage of liquids and gases through the body (3), said body (3) being couplable at an opening (4) of said container (2) for fluids such as to close said opening (4) and exhibiting at least a perforable portion (5) that can be selectively and through-pierced by a piercing element (7) made of a plastic material, at least said perforable portion (5) being made of a halogenated-type butyl-based polyolefin thermo-setting elastomer exhibiting a Shore A hardness value of less than 40 and proof to liquids and gases, at least said perforable portion (5) being further configured for elastically re-establishing a fluid-tight condition in order to prevent passage of liquids and gases through the body (3) following an extraction of said piercing element (7) from the perforable portion (5) of said body (3).

12. The closing element of claim 11, wherein said body (3) is entirely made of said material and/or wherein said butyl-based polyolefin elastomer material is halogenated with bromine and/or is a bromine-butyl rubber or butyl bromine and/or wherein the base polymer of said elastomer material is a brominated isobutene-co-isoprene or brominated isoprene-isobutylene copolymer.

13. The closing element of claim 11, wherein said material exhibits a Shore A hardness value of less than 35, or less than 32, or less than 30 or less than 28.

14. The closing element of claim 11, wherein said material exhibits a Shore A hardness value comprised between 15 and 35 or comprised between 18 and 32 or comprised between 20 and 30 or comprised between 20 and 28.

15. The closing element of claim 11, wherein said body (3) exhibits a thickness, in at least a perforable portion (5) thereof and according to a preferential direction (17) of perforation and/or according to an extraction direction of said fluid, of less than 7 mm or less than 6 mm or less than 5 mm or less than 4 mm or less than 3.5 mm and/or comprised between 1 mm and 7 mm or between 2 mm and 4 mm or between 2.5 and 3.5 mm.

16. The closing element of claim 11, wherein said fluid-tight body (3) exhibits a substantially pastille-shaped and/or substantially cylindrical conformation and/or exhibits a width, in a direction (18, 18′) perpendicular to said preferential direction of perforation (17), comprised between 10 and 25 mm and/or between 15 and 20 mm and/or between 16 and 18 mm and/or exhibits a raised perimeter portion (6) having a greater thickness with respect to the thickness of said perforable portion (5).

17. The closing element of claim 11, wherein said material exhibits a density comprised between 1 and 1.30 g/cm³ and/or between 1.10 and 1.20 g/cm³ and/or about 1.15 g/cm³.

18. The closing element of claim 11, wherein said material exhibits a resistance to laceration comprised between 5 and 20 N/mm and/or between 8 and 18 N/mm and/or between 10 and 16 N/mm.

19. The closing element of claim 11, wherein said material exhibits a breaking load comprised between 4 and 12 MPa and/or between 5 and 11 MPa and/or between 6 and 10 MPa.

20. The closing element of claim 11, wherein said fluid-tight body (3) is able to prevent passage of liquids and gases through the body (3) to maintain liquids and gases in a vacuum condition.

21. A device for containing and transporting biological fluids, comprising: a container (2) for fluids, able to contain at least a fluid; and a closing element (1) according to claim 1, coupled at an opening (4) of said container (2) for closing said opening (4) and for preventing an exit of liquids and gases from said container (2), said closing element (1) being further configured for elastically re-establishing said fluid-tight condition following an extraction of a piercing element (7) from the perforable portion (5) of said body (3).

22. The device of claim 21, wherein said container (2) comprises at least a liquid under a vacuum condition, said closing element (1) being able and configured such as to elastically re-establish said fluid-tight condition, preventing an exit of liquids and gases from said container (2), and maintaining said vacuum condition in said container (2) following an extraction of a piercing element (7) from the perforable portion (5) of said body (3).

23. The device of claim 21, further comprising a cap (9) selectively couplable to said container (2) at said opening (4) such as to maintain said closing element (1) coupled and in a tightly closed position of said container (2).

24. The device of claim 21, wherein said container (2) is a test tube and wherein said cap (9) comprises a threaded ringnut (10) selectively couplable to a corresponding thread (19) of said test tube (18), said cap (9) being provided with at least a passage opening (11) enabling an access to said perforable portion (5) of said closing element (1) by a piercing element.

25. The device of claims 21, further comprising a collecting device (12) having at least a piercing portion (13) made of a plastic material suitably shaped for defining a piercing element (7) able to selectively perforate said perforable portion (5) of said closing element (1).

26. The device of claim 21, wherein said piercing portion (13) exhibits, in a section perpendicular to a main longitudinal extension direction, a diameter comprised between 1 and 4 mm, or between 1.5 and 3.5 mm or between 2 and 3 mm or between 2.3 mm and 2.7 mm.

27. The device of claim 21, wherein said piercing portion (13) is shaped at a point thereof with a profile inclined according to an angle (20) comprised between 10° and 45° or comprised between 15° and 35° or comprised between 20° and 25° such as to facilitate insertion thereof in said perforable portion (5).

28. The device of claim 21, wherein said collecting device (12) further comprises at least a support portion (14) connected to said piercing portion (13) and selectively couplable to said cap (9) and/or to said container (2), in a first operating collecting position, for guiding and maintaining a correct insertion of said piercing portion (13) in said perforable portion (5) and/or wherein it further comprises at least a grip portion (15) connected to said support portion (14) for facilitating manipulation of said perforator element by a user and/or wherein it further comprises at least an engaging portion (16) enabling a selective coupling of said piercing element to said cap (9) and/or said container (2), in a second operating position of non-use and/or of transport and/or wherein said piercing element is entirely made of a plastic material.

29. Use of a closing element (1) according to claim 11, for tightly closing biological fluids for preventing a passage of liquids and gas and/or for tightly closing a vacuum condition of a container (2) or test tube (18).

30. A process for collecting a quantity of a sample of fluid from a device (8) for containing and transporting fluids according to claim 21, comprising the steps of:
inserting the piercing portion (13) of the collecting element through the perforable portion (5) of the closing element (1);
collecting, from the container (2) of said device (8) for containing and transporting fluids, a predetermined quantity of said sample through the piercing portion (13);
extracting said piercing portion (13) of the collecting element from said perforable portion (5) of the closing element (1), said perforable portion closing elastically such as to re-establish a tight condition of fluids, such as to prevent a passage of liquids and gases through the body (3), or for maintaining a vacuum condition in said container (2).
